(19) United States
(12) Patent Application Publication
(10) Pub. No.: US 2008/0036820 A1
(43) Pub. Date: Feb. 14, 2008

(54) Apparatus and Method for Jetting Droplet Using Electrostatic Field

(75) Inventors: Ji Hye Yang, Seoul (KR); Jeong Taek Oh, Gyeonggi-do (KR); Suk Han Lee, Gyeonggi-do (KR); Sang Joon Han, Gyeonggi-do (KR); Han Seo Ko, Seoul (KR); Do Young Byun, Seoul (KR); Yong Jae Kim, Chungcheongbuk-do (KR); Sang Uk Son, Gyeongsangbuk-do (KR)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(73) Assignee: KONKUK UNIVERSITY INDUSTRIAL COOPERATION CORP., Seoul (KR)

(21) Appl. No.: 11/575,258

(22) PCT Filed: Nov. 28, 2005
(86) PCT No.: PCT/KR05/04016

§ 371 Date: Mar. 14, 2007

(30) Foreign Application Priority Data
Feb. 21, 2005 (KR) 10-2005-0013969

(51) Int. Cl. B41J 2/06

(52) U.S. Cl. 347/55

(57) ABSTRACT

Disclosed herein is an apparatus for jetting droplets using an electrostatic field, the apparatus includes a body, a chamber, an actuator, a nozzle, and a pillar-shaped member. The body is configured to contain and support a chamber, an actuator, a nozzle, and a pillar-shaped member and configured. The chamber is formed to have a predetermined volume in the body and accommodate a predetermined amount of fluid. The actuator is formed on the body, and configured to jet the fluid accommodated in the chamber using a controllable electrostatic field. The nozzle is configured to pass through the upper portion of the chamber and the central portion of the actuator, and to allow the fluid accommodated in the chamber to flow therethrough. The pillar-shaped member is located in a direction extending from the longitudinal central axis of the nozzle, and is configured to be electrically grounded and guide the fluid to smoothly flow to the inlet of the nozzle.

### TECHNICAL FIELD

The present invention relates, in general, to an apparatus and method for jetting droplets using an electrostatic field and, more particularly, to an apparatus and method for jetting droplets using an electrostatic field, which apply an electric field (electrostatic field) to the surface of fluid to be jetted through a nozzle, thus efficiently jetting the fluid in droplet form.

### BACKGROUND ART

Generally, an apparatus for jetting (discharging) fluid in droplet form using an electrostatic field has been mainly applied to inkjet printers in various ways. Such an apparatus is recently being developed to be applicable to display manufacturing apparatuses, printed circuit board manufacturing apparatuses, and high value added fields having, such as DNA chip manufacturing process.

In the inkjet printers, apparatuses for jetting ink in droplet form are classified into a heat driven type and an electrostatic force type.

A heat driven-type ink jetting apparatus, as shown in FIGS. 1A and 1B, includes a manifold 22 provided in a substrate 10, an ink channel 24 and an ink chamber 26 defined by a partition wall 14 formed on the substrate 10, a heater 12 provided in the ink chamber 26, and a nozzle 16 provided in a nozzle plate 18 to jet an ink droplet 29′. The heat driven type-ink jetting apparatus jets the ink droplet 29′ through the following operation.

When voltage is applied to the heater 12, heat is generated and, thereby, ink 29 charged in the ink chamber 26 is heated, so that a bubble 28 is generated.

Thereafter, the generated bubble 28 is continuously expanded and, therefore, pressure is applied to the ink 29 charged in the ink chamber 26, so that the ink droplet 29′ is jetted outside the nozzle 16 through the nozzle 16.

Thereafter, ink 29 is drawn from the manifold 22 into the ink chamber 26 through the ink channel 24 and, thereby, the ink chamber 26 is refilled with the ink 29.

However, the conventional heat driven-type ink jetting apparatus may cause chemical variation in the ink 29 due to the heat of the heater 12 for forming the bubble, so that it is disadvantageous in that problems, such as the degradation of the quality of the ink 29, may occur.

Furthermore, while the droplet 29′ of the ink jetted through the nozzle 16 moves toward a target object, such as paper, the volume thereof may vary rapidly due to the heat of the heater 12, so that a problem occurs in that print quality, such as resolution, is degraded.

Furthermore, the apparatus for jetting ink using a heat driven method is problematic in that it has limitation in the fine control of the droplet 29′ jetted through the nozzle 16, for example, the control of the size and shape of the droplet 29′.

Furthermore, a problem occurs in that it is difficult to implement a highly integrated apparatus for jetting droplets, due to the above-described problems.

Meanwhile, FIGS. 2A and 2B show a different type ink jetting apparatus, that is, an electrostatic force driven type ink jetting apparatus using an electric field.

In more detail, the electrostatic force driven-type apparatus, as shown in FIGS. 2A and 2B, includes a base electrode 32, and an opposite electrode 33 located to face the base electrode 32. Ink 31 is introduced between the two electrodes 32 and 33, and a Direct Current (DC) power source 34 is connected to the electrodes 32 and 33.

When voltage from the DC power source 34 is applied to the electrodes 32 and 33, an electrostatic field is formed between the electrodes 32 and 33.

Accordingly, Coulomb's force, which acts in a direction toward the opposite electrode 33, acts on the ink 31.

Meanwhile, force resisting the Coulomb's force also acts on the ink 31 due to the intrinsic surface tension and viscosity of the ink 31, so that the ink 31 is not easily jetted in the direction toward the opposite electrode 33.

Accordingly, a very high voltage of more than 1 kV must be applied between the electrodes 32 and 33 to separate the droplet from the surface of the ink 31 and jet the separated droplet.

However, when such a high voltage is applied between the electrodes 32 and 33, droplets are irregularly jetted, so that the ink 31 heats up locally.

That is, the temperature T1 of the ink 31′ located in region S1 increases above the temperature T0 of the ink 31 located in other regions, so that a plurality of electrons gathers because the ink 31′ in the region S1 is expanded and the electrostatic field is concentrated in this region.

Accordingly, a repulsive force existing between the charges of ink 31′ and Coulomb's force based on the electrostatic field act on the ink 31′ of region S1, so that the droplet is separated from the ink 31′ of the region S1 and is then moved toward the opposite electrode 33, as shown in FIG. 2B.

However, the above-described electrostatic force driven-type ink jetting apparatus is problematic in that a very high voltage of more than 1 kV must be applied to the electrodes 32 and 33, and the external opposite electrode 33 must also be provided on a side opposite to the nozzle.

### DISCLOSURE OF THE INVENTION

Accordingly, the present invention has been made keeping in mind the above problems occurring in the prior art, and an object of the present invention is to provide an apparatus and method for jetting droplets using an electrostatic field, which can jet fluid in droplet form without the conventionally encountered thermal variation by applying a controllable electrostatic field to the surface of the fluid to be jetted through a nozzle, which can control jetted droplets using a plurality of electrodes stacked at the front end of the outlet of the nozzle without using a separate external electrode, and which can be driven by a low voltage.

In order to accomplish the above object, the present invention provides an apparatus for jetting droplets using an electrostatic field, the apparatus including a body configured to contain and support a chamber, an actuator, a nozzle, and a pillar-shaped member and configured; the chamber formed to have a predetermined volume in the body and accommodate a predetermined amount of fluid, including liquid and particles that is provided from an outside; the actuator formed on the body, and configured to jet the fluid accommodated in the chamber using a controllable electrostatic field; the nozzle configured to pass through the upper portion of the chamber and the central portion of the actuator, and to allow the fluid accommodated in the chamber to flow therethrough; and the pillar-shaped member located in a direction extending from the longitudinal central axis of the nozzle, the lower portion of which is coupled with a bottom of the body, and the upper tip of which is located close to the inlet of the nozzle, and is configured to be electrically grounded and guide the fluid to smoothly flow to the inlet of the nozzle.

It is preferred that, when the apparatus comprises a plurality of apparatuses for jetting droplets that are arranged in an array, the body contain a plurality of chambers, actuators, nozzles, and pillar-shaped members.

Furthermore, it is preferred that the apparatus further include an electrowetting device configured to be disposed in the central portion of the bottom of the body and push up the surface of the fluid, which is accommodated in the chamber, in a direction toward the inlet of the nozzle using electrowetting.

Furthermore, it is preferred that the body is electrically grounded.

Furthermore, it is preferred that the chamber is formed in a pyramid shape as viewed in a longitudinal section thereof.

Furthermore, it is preferred that the actuator include N-1 electrodes and N insulation layers that are alternately stacked.

Furthermore, it is preferred that the nozzle is coated on the inner surface thereof with a single hydrophobic film, or with hydrophobic and hydrophilic films that are alternately disposed at predetermined intervals in a transverse direction.

Furthermore, it is preferred that the nozzle be formed in a circular shape as viewed in a transverse section of the nozzle.

It is preferred that the N-1 electrodes be supplied with predetermined voltages through a power source unit for supplying the voltages and a control unit for controlling the power source unit and forms an electrostatic field, wherein the absolute potential of voltage applied to the upper electrode of the N-1 electrodes is higher than that of voltage applied to the lower electrode of the N-1 electrodes.

In addition, the present invention provides a method of jetting droplets using an apparatus for jetting droplets, the apparatus having a body, a chamber, an actuator, a nozzle, and a pillar-shaped member, the method including the steps of: accommodating fluid, including liquid and particles, in the chamber; and controlling the potentials of voltages respectively applied to N-1 electrodes, which are provided in the actuator, through a power source unit and a control unit for controlling the power source unit, and application time of the voltages, thereby determining the jetting velocity of droplets jetted outside the nozzle, and the acceleration of the droplets depending on the jetting velocity, and the shape of the droplets.

It is preferred that the N-1 electrodes be supplied with predetermined voltages through a power source unit for supplying the voltages and a control unit for controlling the power source unit and forms an electrostatic field, wherein the absolute potential of voltage applied to the upper electrode of the N-1 electrodes is higher than that of voltage applied to the lower electrode of the N-1 electrodes.

Furthermore, it is preferred that the method further include an electrowetting device configured to be disposed in the central portion of the bottom of the body and push up the surface of the fluid, which is accommodated in the chamber, in a direction toward the inlet of the nozzle using electrowetting.

### BRIEF DESCRIPTION OF THE DRAWINGS

The above and other objects, features and other advantages of the present invention will be more clearly understood from the following detailed description taken in conjunction with the accompanying drawings, in which:

FIGS. 1A and 1B are views showing an example of a conventional heat driven-type apparatus;

FIGS. 2A and 2B are views showing an example of a conventional electrostatic force driven-type apparatus for;

FIG. 3 is a longitudinal section showing the schematic construction of an apparatus for jetting droplets using an electrostatic field according to an embodiment of the present invention;

FIG. 4 is a view schematically illustrating an example of a process of jetting droplets according to an embodiment of the present invention;

FIG. 5 is a view simulating the lines of electrostatic force applied to the upper surface of fluid by an actuator according to an embodiment of the present invention;

FIGS. 6A and 6B are views illustrating electrowetting;

FIG. 6C is a view showing an example of an apparatus for jetting droplets using an electrostatic field, to which a separate electrowetting device according to an embodiment of the present invention is applied; and

FIGS. 7A and 7B are views showing an example of an apparatus array for jetting droplets using an electrostatic field according to an embodiment of the present invention.

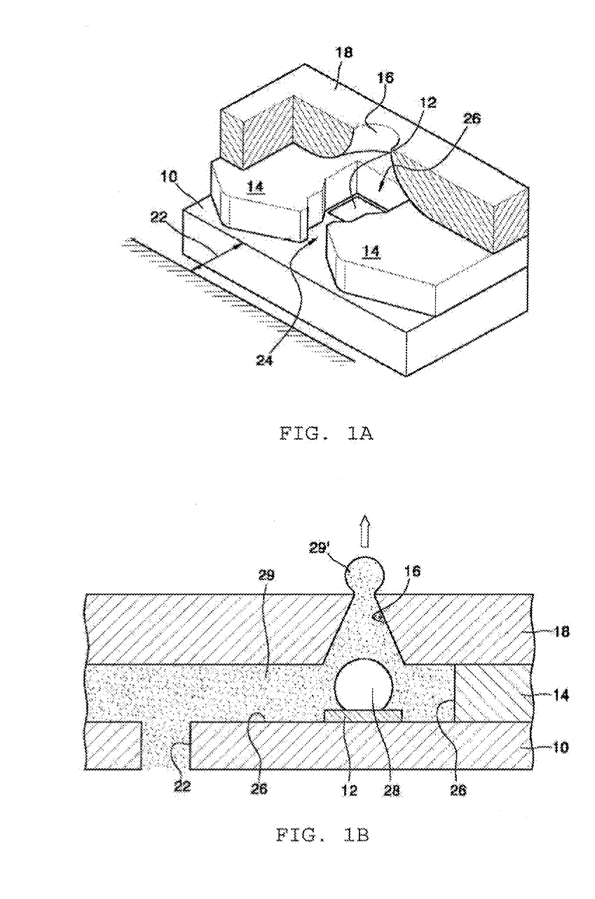

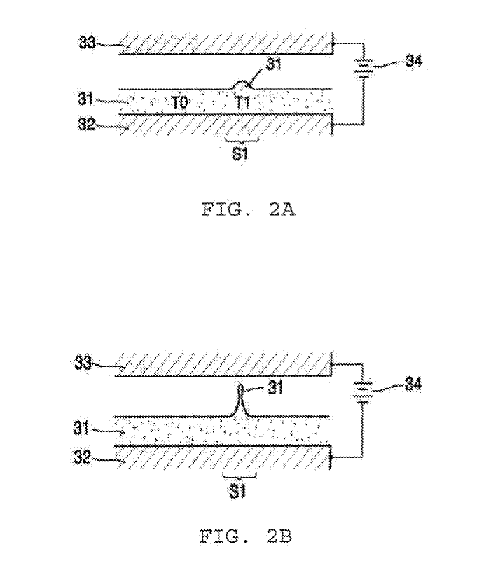

### BEST MODE FOR CARRYING OUT THE INVENTION

The present invention is described in detail with reference to the accompanying drawings below.

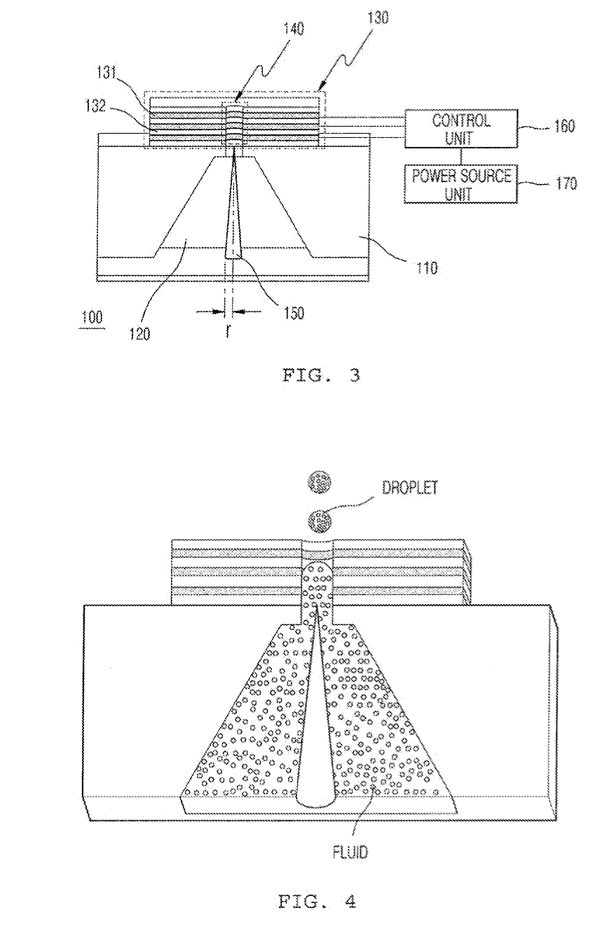

An apparatus for jetting droplets using an electrostatic field according to an embodiment of the present invention is described with reference to FIG. 3 below.

FIG. 3 is a longitudinal section schematically showing the construction of the apparatus for jetting droplets using an electrostatic field according to an embodiment of the present invention.

As shown in FIG. 3, the apparatus 100 for jetting droplets using an electrostatic field (hereinafter referred to as a “droplet jetting apparatus”) includes a body 110, a chamber 120, an actuator 130, a nozzle 140, a pillar-shaped member 150, a control unit 160, and a power source unit 170.

The body 110 contains the chamber 120, the actuator 130, the nozzle 140 and the pillar-shaped member 150, and performs a supporting function.

The body 110 is formed through a process of etching a silicon wafer, and it is preferred that the chamber 120, the actuator 130, the nozzle 140 and the pillar-shaped member 150 also be formed through the etching process.

Furthermore, the chamber 120 is formed to have a predetermined volume in the body 110, thus performing a function of receiving fluid through a channel that communicates with the chamber 120 and accommodating a predetermined amount of supplied fluid, although not shown in FIG. 3.

In this case, the chamber 120, as shown in FIG. 3, has a pyramid shape as viewed in the longitudinal section of the chamber 120. The upper portion of the chamber 120 communicates with the lower portion of the nozzle 140.

Since the chamber 120 has a pyramid shape as described above, there is an structural advantage in that fluid flowing into the chamber 120 can be smoothly supplied to the nozzle 140.

Furthermore, the inner surface of the chamber 120 is coated with a hydrophilic film, so that the fluid supplied into the chamber 120 through the channel is more reliably accommodated therein. Furthermore, in the case where the fluid is jetted to the outside through the nozzle 140, the chamber 120 can more smoothly supplied with fluid in proportion to the amount of the jetted fluid from the outside through the channel.

Capillary attraction can be employed as a general method of receiving fluid from the outside through the channel.

Although, for reference, the fluid has been described as being accommodated in the chamber 120, it is preferred that the fluid be thought of as a flowable fluid, that is, a colloid, including liquid and particles, like the ink used in the inkjet printers.

Although, in the present embodiment, the inner surface of the chamber 120 has been described as being coated with a hydrophilic film, the present invention is not limited to this.

In the present embodiment, the body 110 containing the chamber 120 may be electrically grounded.

Furthermore, the actuator 130 is formed on the body 110, and the nozzle 140 communicates with the central portion of the actuator 130. The actuator 130 performs a function of jetting the fluid, which has been charged in the chamber 120, in droplet form using a controllable electrostatic field.

In more detail, the actuator 130 includes N-1 electrodes 131 and N insulation layers 132, which are alternately stacked in such a manner that the N-1 electrodes 131 are interposed between the N insulation layers.

In regard to the electrodes 131 and the insulation layers 132, the insulation layers 132, as shown in FIG. 3, constitute the lower portion of the actuator 130, which abuts the upper portion of the body 110, and the upper portion of the actuator 130, so that the body 110 and the electrodes 131 are electrically insulated from each other.

In this case, each of the electrodes 131 is electrically connected to the control unit 160.

Although, in the present embodiment, the number of electrodes 131 is set to three and the number of insulation layers 132 is set to four, that is, N is set to four, the present invention is not limited to this value.

Furthermore, the nozzle 140 passes through the upper portion of the chamber 120 and the central portion of the actuator 130, and performs a function of allowing the fluid accommodated in the chamber 120 to flow out therethrough.

The nozzle 140 has a circular shape as viewed in the transverse section of the nozzle 140, and the inner surface thereof is coated with hydrophobic and hydrophilic films that are alternately disposed at predetermined intervals as viewed in the transverse section of the nozzle 140.

When the fluid moves through the nozzle 140, the upper surface (meniscus) of the fluid having a semicircular shape may become instable.

Although, in the present embodiment, the nozzle 140 has been described as having a circular shape as viewed in the transverse section of the nozzle 140, it is apparent that the present invention is not limited to this shape.

A process of moving the fluid through the nozzle 140 is described below.

Although, in the present embodiment, the inner surface of the nozzle 140 has been described as being coated with hydrophobic and hydrophilic films that are alternately disposed at predetermined intervals as viewed in the transverse section of the nozzle 140, the present invention is not limited to these films, and the entire inner surface of the nozzle 140 may be coated only with a hydrophobic film.

Meanwhile, the pillar-shaped member 150 is electrically grounded. Furthermore, as shown in FIG. 3, the lower circular end of the pillar-shaped member 150, having a predetermined radius r, is coupled to the central portion of the bottom of the body 110, and the upper tip of the pillar-shaped member 150 is located at a distance or a height L that reaches the lowermost insulation layer 132 of the actuator 130. The entire pillar-shaped member 150 is located in a direction extending from the longitudinal central axis of the nozzle 140.

The pillar-shaped member 150 performs a function of guiding the fluid, which is accommodated in the chamber 120, to smoothly flow to the inlet of the nozzle 140.

In addition, the pillar-shaped member 150 has a conical shape, so that the fluid can be smoothly guided to the inlet of the nozzle 140, that is, the lower portion of the nozzle 140, without the flow of the fluid being hindered.

In the present embodiment, it is apparent that the total volume of fluid accommodated in the chamber 150 varies with the set values of the radius r and height L of the pillar-shaped member 150 having a conical shape, and that the total area of the pillar-shaped member 150 that comes into contact with the fluid accommodated in the chamber 120 also varies therewith. Accordingly, the present invention is not limited to any set values of the radius r and height L thereof.

Furthermore, although, in the present embodiment, the pillar-shaped member 150 has been described as having a conical shape, the present invention is not limited to this, and the pillar-shaped member 150 may have a typical pillar shape.

The control unit 160 is electrically connected to the power source unit 170 and the electrodes 131 of the actuator 130, and performs a function of applying voltage, which is received through the power source unit 170, to the electrodes 131.

In more detail, the control unit 160 performs a control function such that voltages, each of which has an independent level, can be supplied to respective electrodes 131, and it is preferred that the control unit 160 may be included in a higher class system that adopts the droplet jetting apparatus 100 having the above-described construction.

The power source unit 170 performs a function of supplying voltage to the electrodes 131 under the control of the control unit 160, and it is preferred that the power source unit 170 may be included in the higher class, like the control unit 160.

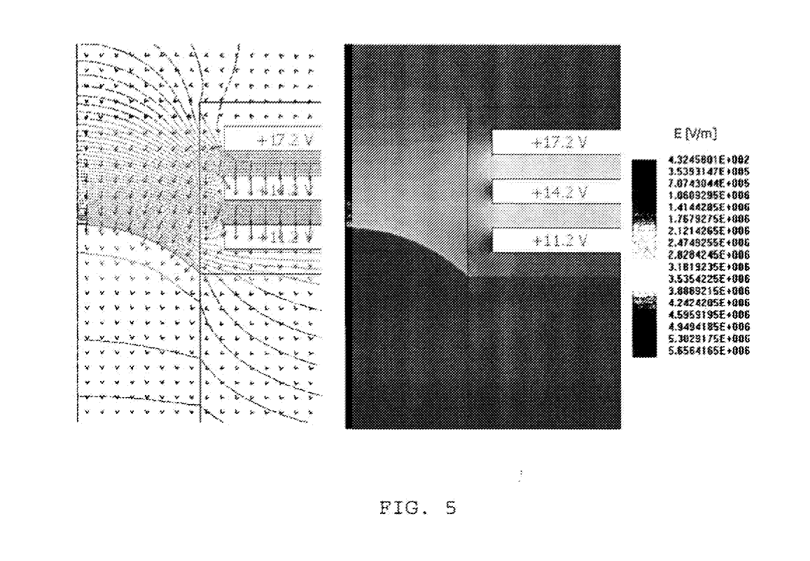

Until now, the overall construction of the droplet jetting apparatus 100 according to an embodiment of the present has been described. Henceforth, the detailed operation of the droplet jetting apparatus 100 according to the embodiment of the present is described with reference to FIG. 4 to 6C below.

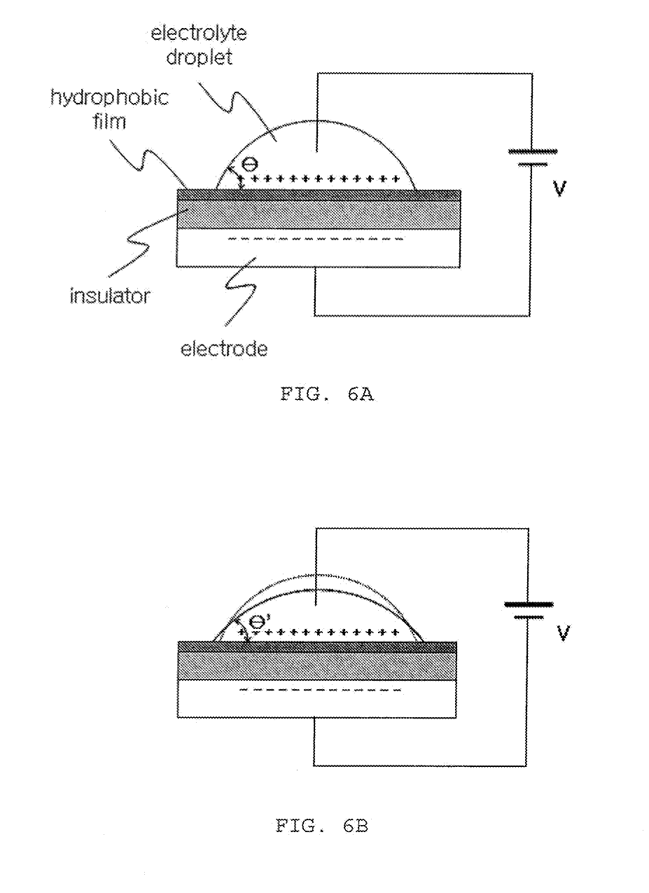

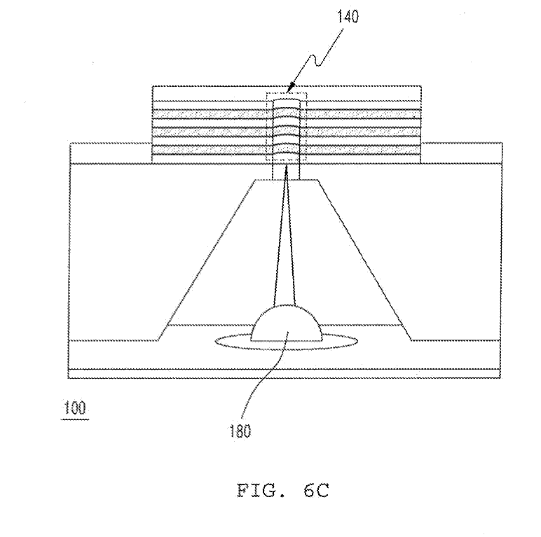

FIG. 4 is a view illustrating an example of a schematic process of jetting droplets according to an embodiment of the present invention, FIG. 5 is a view simulating the lines of electrostatic force applied to the upper surface of fluid by an actuator according to an embodiment of the present invention, FIGS. 6A and 6B are views illustrating electrowetting, and FIG. 6C is a view showing an example of a droplet jetting apparatus using an electrostatic field, to which a separate electrowetting device according to an embodiment of the present invention is applied.

As shown in FIG. 4, the interior of the chamber 120 is filled with fluid, and the pillar-shaped member 150 is electrically grounded, as described above.

Although, in the present embodiment, the pillar-shaped member 150 has been described as being electrically grounded, the present invention is not limited to this, and the body 110 may also be electrically grounded.

Meanwhile, predetermined voltages, which can be controlled, are respectively applied to the electrodes 131, included in the actuator 130, through the control unit 160 and the power source unit 170.

In order to clearly describe the technical spirit of the present invention, the number of electrodes 131 is set to three. In this case, as shown in FIG. 4, voltages, having potentials of +11.2 V, +14.2 V, and +17.2 V, may be respectively applied to the three electrodes ranging from the uppermost electrode to the lowermost electrode.

Meanwhile, the fluid accommodated in the chamber 120 moves in a direction toward the uppermost electrode due to electrostatic force and, therefore, the fluid is drawn upward in a state in which the surface of the fluid has a semicircular shape (meniscus) in the interior of the nozzle 140, as shown in FIG. 4.

At this time, the fluid moves toward the outlet of the nozzle 140.

That is, the fluid moves toward the upper electrode, having an absolute potential higher than the absolute potential of voltage applied to the uppermost electrode, and the droplet shown in FIG. 4 starts to be jetted from the central portion of the surface of the fluid to the outside of the nozzle 140 as the intensity (density) of the electrostatic field formed by the electrodes increases.

It is preferred that particles in the fluid be concentrated in the central portion of the surface of the fluid having a semicircular shape.

The jet velocity of droplets jetted through the nozzle 140, the acceleration of the droplets depending on the jet velocity, and the shape of the droplets can be finely controlled depending on the magnitude of voltage applied to each electrode and the application time of the voltage.

Viewing the electrodes 131 formed around the nozzle 140 according to the present invention in the transverse section, it is apparent that the intensity (density) of the electrostatic field concentrated in the central portions of the electrodes is high, as shown in FIG. 5.

In the present embodiment described above, the electrowetting may be used for a pumping operation of changing the surface of fluid into a semicircular shape (meniscus), while the fluid initially moves to a boundary at which the surface characteristic of the nozzle 140 varies from a hydrophilic state to a hydrophobic state.

The electrowetting is briefly described below.

An electrowetting method is the most attractive of the various methods of finely controlling a microscopic flow field. As shown in FIGS. 6A and 6B, the electorwetting method refers to a method in which the contact angle (Θ) or Θ′) of the droplet varies when DC voltage V is applied to an electrolyte droplet located on an electrode coated with a hydrophobic film and an insulator.

In this case, the contact angle of the electrolyte droplet varies with the magnitude of the applied DC voltage V.

As can be seen through the present embodiment, the electrowetting is advantageous in that it can quickly and efficiently control the flow of droplets using a relatively low voltage (less than 100 V), and makes the reversible transfer and control of fluid possible.

A device 180 using the electrowetting (hereinafter refered to as an “electrowetting device”), as shown in FIG. 6C, is separately provided at the bottom of the droplet jetting apparatus 100, that is, opposite the nozzle 140. The surface of the fluid is pushed from the hydrophilic surface to the hydrophobic surface by the electrowetting device 180 at the early driving stage of the droplet jetting apparatus 100 and, therefore, the droplet can be easily formed.

As described above, in a process of jetting droplets to the outside of the nozzle 140 through the actuator 130 including the electrodes 131, the present invention is advantageous in that droplets can be smoothly jetted without an opposite electrode being installed on the outside, unlike the conventional droplet jetting apparatus using an electrostatic force.

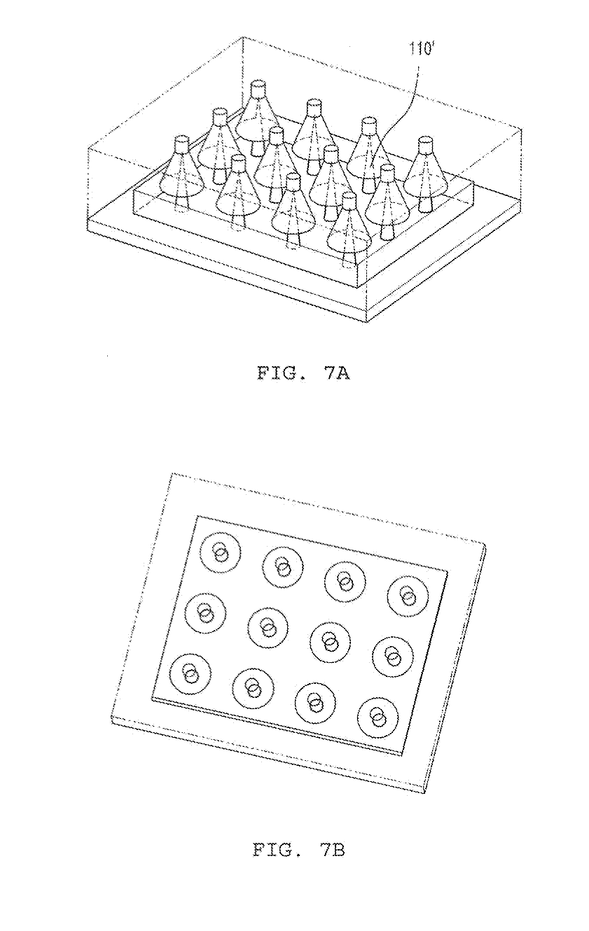

Meanwhile, the droplet jetting apparatuses according to an embodiment of the present invention, which have the construction and characteristic operation described above, as shown in FIGS. 7A and 7B, may be configured to be arranged in a highly integrated array, and it is preferred that the droplet jetting apparatuses 100, which are configured to be arranged in an array, be able to jet droplets individually under the control of the control unit 160.

In more detail, when the droplet jetting apparatus includes a plurality of droplet jetting apparatuses that are configured to be arranged in an array, a single body 110′, as shown in FIGS. 7A and 7B, contains a plurality of droplet jetting apparatuses, each of which has the above-described components, that is, the chamber 120, the actuator 130 including the electrodes 131 and the insulation layer 132, the nozzle 140, and the pillar-shaped member 150, thereby constituting a structure capable of individually jetting droplets.

In accordance with the present invention described above, the controllable electrostatic field is applied to the surface of the fluid to be jetted through the nozzle, so that the fluid can be jetted in droplet form without conventionally encountered thermal variation. Furthermore, jetted droplets can be finely controlled using the plurality of electrodes stacked at the front end of the outlet of the nozzle without requiring a separate external electrode (opposite electrode). Furthermore, the droplet jetting apparatus of the present invention can be easily driven at a low voltage.

Furthermore, in accordance with the present invention, when a plurality of droplet jetting apparatuses, each of which has the above-described components, are arranged at predetermined intervals, the droplet jetting apparatuses are not influenced by the conventional thermal problems, so that a highly integrated array can be achieved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An apparatus for jetting droplets using an electrostatic field, the apparatus comprising:
a body configured to contain and support a chamber, an actuator, a nozzle, and a pillar-shaped member and configured;
the chamber formed to have a predetermined volume in the body and accommodate a predetermined amount of fluid, including liquid and particles that is provided from an outside;
the actuator formed on the body, and configured to jet the fluid accommodated in the chamber using a controllable electrostatic field;
the nozzle configured to pass through an upper portion of the chamber and a central portion of the actuator, and to allow the fluid accommodated in the chamber to flow therethrough; and
the pillar-shaped member located in a direction extending from a longitudinal central axis of the nozzle, a lower portion of which is coupled with a bottom of the body, and an upper tip of which is located close to an inlet of the nozzle, and is configured to be electrically grounded and guide the fluid to smoothly flow to the inlet of the nozzle.

2. The apparatus according to claim 1, wherein, when the apparatus comprises a plurality of apparatuses for jetting droplets that are arranged in an array, the body contains a plurality of chambers, actuators, nozzles, and pillar-shaped members.

3. The apparatus according to claim 1 or 2, further comprising an electrowetting device configured to be disposed in a central portion of the bottom of the body and push up a surface of the fluid, which is accommodated in the chamber, in a direction toward the inlet of the nozzle using electrowetting.

4. The apparatus according to claim 1 or 2, wherein the body is electrically grounded.

5. The apparatus according to claim 1 or 2, wherein the chamber is formed in a pyramid shape as viewed in a longitudinal section thereof.

6. The apparatus according to claim 1 or 2, wherein the actuator comprises N-1 electrodes and N insulation layers that are alternately stacked.

7. The apparatus according to claim 1 or 2, wherein the nozzle is coated on an inner surface thereof with a single hydrophobic film, or with hydrophobic and hydrophilic films that are alternately disposed at predetermined intervals in a transverse direction.

8. The apparatus according to claim 1 or 2, wherein the nozzle is formed in a circular shape as viewed in a transverse section of the nozzle.

9. The apparatus according to claim 6, wherein the N-1 electrodes are supplied with predetermined voltages through a power source unit for supplying the voltages and a control unit for controlling the power source unit and forms an electrostatic field, wherein an absolute potential of voltage applied to an upper electrode of the N-1 electrodes is higher than that of voltage applied to a lower electrode of the N-1 electrodes.

10. A method of jetting droplets using an apparatus for jetting droplets, the apparatus having a body, a chamber, an actuator, a nozzle, and a pillar-shaped member, the method comprising the steps of:
accommodating fluid, including liquid and particles, in the chamber; and
controlling potentials of voltages respectively applied to N-1 electrodes, which are provided in the actuator, through a power source unit and a control unit for controlling the power source unit, and application time of the voltages, thereby determining jetting velocity of droplets jetted outside the nozzle, and acceleration of the droplets depending on the jetting velocity, and a shape of the droplets.

11. The method according to claim 10, wherein the N-1 electrodes are supplied with predetermined voltages through a power source unit for supplying the voltages and a control unit for controlling the power source unit and forms an electrostatic field, wherein an absolute potential of voltage applied to an upper electrode of the N-1 electrodes is higher than that of voltage applied to a lower electrode of the N-1 electrodes.

12. The method according to claim 10, further comprising an electrowetting device configured to be disposed in a central portion of the bottom of the body and push up a surface of the fluid, which is accommodated in the chamber, in a direction toward an inlet of the nozzle using electrowetting.
